(19) United States
(12) Patent Application Publication
(10) Pub. No.: US 2026/0262880 A1
(43) Pub. Date: Sep. 10, 2026

(54) Air Fryer With Heating Plate

(71) Applicant: SHENZHEN CHENBEI TECHNOLOGY CO., LTD., SHENZHEN (CN)

(72) Inventors: Min Lin, SHENZHEN (CN); Weihao Gu, SHENZHEN (CN); Zhipeng Huang, SHENZHEN (CN)

(73) Assignee: SHENZHEN CHENBEI TECHNOLOGY CO., LTD., SHENZHEN, GD (CN)

(21) Appl. No.: 18/868,138

(22) PCT Filed: Sep. 14, 2024
(86) PCT No.: PCT/CN2024/119145

§ 371 Date: Nov. 21, 2024

(30) Foreign Application Priority Data
Oct. 16, 2023 (CN) 202322771681.9

(51) Int. Cl. A47J 37/06

(52) U.S. Cl. CPC A47J 37/0641; A47J 37/0635

(57) ABSTRACT

The utility model relates to an air fryer, comprising a cover body and a frying receptacle, wherein the cover body has a reflective cover for accommodating a heating device, the frying receptacle has a cooking chamber for placing food, the cover body is constructed to cover the frying receptacle, and the heating device comprises a heating element and a fan arranged above the heating element. The heating device also includes a heat conductive plate arranged below the fan. The heat conductive plate and/or the reflective cover are provided with a circulation channel. The circulation channel connects the reflective cover and the cooking chamber. At least a part of the airflow generated when the fan is in operation enters and exits at least one circulation channel, thereby generating air convection between the reflective cover and the cooking chamber. The utility model can reduce the grease in the cover body.

### CROSS-REFERENCE TO RELATED APPLICATIONS

This application claims the benefit of the priority filing date of PCT application number PCT/CN2024/119145, filed on Sep. 14, 2024, which claims the benefit of the priority filing date of Chinese patent application number CN202322771681.9, entitled “Air Fryer,” filed on Oct. 16, 2023, which is hereby cited in its entirety as a reference.

### TECHNICAL FIELD

The present utility model relates to the technical field of cooking appliances, in particular to an air fryer.

### BACKGROUND OF THE INVENTION

In the existing air fryer, the heating element and fan of the cover body and the frying receptacle for placing food are located in one space. The fan is used as a power source to generate convection of air in the space, and the heat generated by the heating element heats the food in the frying receptacle through two heat conduction methods: air convection and direct radiation.

However, when the air circulates rapidly in the frying receptacle chamber, the moisture and grease in the fryer will be spread throughout the space along with the circulation of hot air. Therefore, the cover body containing components such as heating elements and fans is easily contaminated by grease. Since the cover body is usually compact and the heating tube is mostly annular and disk-shaped with a complex structure, it is difficult for users to clean it. Long-term use will cause the entire cover body to be covered with oil stains, which is not good for health and sensory experience.

### SUMMARY OF THE INVENTION

Therefore, the task of the utility model is to reduce the pollution of grease to the cover body.

In order to achieve the above task, the utility model provides an air fryer, comprising a cover body and a frying receptacle, wherein the cover body has a reflective cover for accommodating a heating device, the frying receptacle has a cooking chamber for placing food, the cover body is constructed to cover the frying receptacle, and the heating device comprises a heating element and a fan arranged above the heating element.

According to the utility model, the heating device also includes a heat conductive plate arranged below the fan. The heat conductive plate and/or the reflective cover are provided with a circulation channel. The circulation channel connects the reflective cover and the cooking chamber. At least a part of the airflow generated when the fan is in operation enters and exits the circulation channel, thereby generating air convection between the reflective cover and the cooking chamber.

In the air fryer proposed by the utility model, by providing a heat conductive plate, the entry of grease into the cover body is reduced, at least the pollution of the reflective cover and the fan by the grease is reduced, so that the overall structure of the cover body is simple and convenient for users to clean after use. Furthermore, since the plate is heat conductive, the addition of the plate does not affect the heating of the food in the cooking chamber by heat radiation from the heating element.

In some embodiments, the heat conductive plate may be disposed below the heating element. This can reduce the contamination of the heating element by grease.

In some embodiments, the heat conductive plate and the heating element may be constructed as an integrated heating plate, that is, the heating element is integrated into the plate or the plate has a heating function. By using an integrated heating plate to replace the traditional heating tube, the space occupied by the original complex heating element is released, making the entire cover space more compact, improving the efficiency of radiant heat conduction, and benefiting air circulation. The freed space can be used to place the first air guide structure, thereby further improving the efficiency of air convection without increasing the volume of the cover body.

In some embodiments, the heat-generating plate can be constructed based on one of thick film heating technology, heat-generating thin film technology, and graphene technology.

In some embodiments, a first guide structure may be provided, wherein the first guide structure is configured to guide the airflow passing through one of the circulation channels into the cooking chamber along a predetermined direction. By providing the first guide structure, the influence of the plate on the air convection in the frying receptacle is reduced, so that the air circulation in the frying receptacle is smoother, and the temperature field and air volume distribution in the frying receptacle are more uniform, which is conducive to the cooking of food.

In some embodiments, the first guide structure may have an inclined guide plate, which is configured to guide the airflow passing through one of the circulation channels toward the middle of the cooking chamber or around the cooking chamber.

In some embodiments, a first circulation channel may be provided in the middle of the heat-conducting plate, and a second circulation channel may be provided between the heat conductive plate and the reflective cover, so that at least a portion of the airflow generated when the fan is in operation flows from the reflective cover into the cooking chamber via the second circulation channel and flows back from the cooking chamber to the reflective cover via the first circulation channel to form the air convection.

In some embodiments, a first guide structure may be provided, wherein the first guide structure is configured to guide the airflow passing through the second circulation channel into the cooking chamber along a predetermined direction.

In some embodiments, the heat conductive plate can be fixed on the reflection cover.

In some embodiments, the heat conductive plate may be configured to move relative to the fan. This allows the position of the heat conductive plate relative to the fan to be adjusted according to the specific design of the air fryer to achieve optimal air circulation.

In some embodiments, the heat conductive plate may be disposed on the reflective cover in a manner movable relative to the fan.

In some embodiments, the first flow guiding structure may be fixed to the reflective cover, and/or the first flow guiding structure may be configured to be movable relative to the fan.

In some embodiments, the first flow guiding structure may be disposed on the heat conductive plate.

In some embodiments, the first flow guiding structure is fixed on the reflective cover, and a second flow guiding structure independent of the first flow guiding structure is arranged on the heat conductive plate, and the second flow guiding structure is constructed to cooperate with the first flow guiding structure to guide the airflow passing through one of the circulation channels into the cooking chamber along a predetermined direction.

### BRIEF DESCRIPTION OF DRAWINGS

To better describe and illustrate the embodiments and/or examples of the inventions disclosed herein, reference may be made to one or more of the Attached Drawings. Additional details or examples used to describe the Attached Drawings should not be considered as limiting the scope of the disclosed inventions, the presently described embodiments and/or examples, and the presently understood best mode of these inventions.

FIG. 1 shows a first embodiment of an air fryer according to the present utility model.

FIG. 2 shows a second embodiment of an air fryer according to the present utility model.

FIG. 3 shows an embodiment of a heat conductive plate of an air fryer according to the present utility model.

FIG. 4 shows a third embodiment of an air fryer according to the present utility model.

FIG. 5 shows a fourth embodiment of an air fryer according to the present utility model.

FIG. 6 shows a fifth embodiment of an air fryer according to the present utility model.

FIG. 7 shows an embodiment of an integrated heating plate of the air fryer according to the present utility model.

FIG. 8 shows a sixth embodiment of an air fryer according to the present utility model.

FIG. 9 shows a seventh embodiment of an air fryer according to the present utility model.

FIG. 10 shows an eighth embodiment of an air fryer according to the present utility model.

FIG. 11 shows a ninth embodiment of an air fryer according to the present utility model.

### DETAILED DESCRIPTION OF THE INVENTION

The technical solutions in the embodiments of the present application will be described clearly and completely with reference to the Attached Drawings of the embodiments of the present application. It is apparent that the embodiments described are only some of the embodiments of the present application and do not constitute all embodiments. Based on the embodiments in the present application, all other embodiments obtained by those of ordinary skill in the art without creative labor are within the scope of protection of the present application.

The embodiments of the present utility model will be described clearly and completely below in conjunction with the accompanying drawings. It is clear that the described embodiments are only some of the embodiments of the present utility model, rather than all embodiments. Based on the embodiments of the utility model, all other embodiments obtained by ordinary technicians in this field without making any creative work shall fall within the scope of protection of the utility model.

Throughout the specification, unless otherwise specifically stated, the terms used herein should be understood as having the meanings commonly used in the art. Therefore, unless otherwise defined, all technical and scientific terms used herein have the same meaning as commonly understood by those skilled in the art to which the utility model belongs. In case of conflict, this manual takes precedence.

It should be noted that the terms “first, second, and third” involved in the embodiments of the present utility model are merely used to distinguish similar objects and do not represent a specific ordering of the objects. It can be understood that “first, second, and third” can be interchanged with a specific order or sequence where permitted. It should be understood that the objects distinguished as “first, second, and third” can be interchanged under appropriate circumstances.

As mentioned in the background technology, due to air circulation, the grease of the food in the frying receptacle will be brought into the cover by the circulating air, and most of the grease will adhere to the reflective cover. Due to the obstruction of the heating tube and the fan, it is difficult for the user to clean the reflective cover. After long-term use, a large area of grease will adhere to the inner side of the reflective cover of the cover.

Based on this, the utility model provides a new type of air fryer that can reduce the contamination of the cover body by grease.

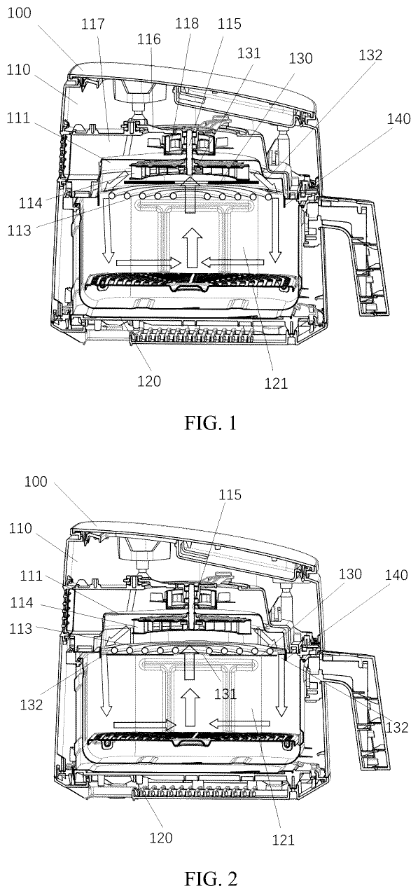

FIG. 1 shows a first embodiment of an air fryer according to the present utility model. As shown in FIG. 1, the air fryer 100 according to the present utility model includes a cover body 110 and a frying receptacle 120. The cover body 110 has a reflective cover 111 for accommodating a heating device. The frying receptacle 120 has a cooking chamber 121 for placing food. Here, the cover body 110 is configured to cover the frying receptacle 120. The cover body 110 may be integrally formed with the frying receptacle 120 as shown in FIG. 1, or the cover body 110 and the frying receptacle 120 may be detachably formed.

In the present utility model, the reflective cover 111 is used to reflect the heat generated by the heating element 113 toward the cooking chamber 121. The reflective cover 111 may be made of metal, for example.

The heating device includes a heating element 113 for generating heat and a fan 114 disposed above the heating element 113 for generating airflow.

The heating element 113 may be configured as a heating tube, for example. The fan 114 may have centrifugal blades, for example, for blowing air around and sucking air in the middle, so that the hot air circulates in the air fryer.

In accordance with the present disclosure, the heating device also includes a heat conductive plate 130 arranged below the fan 114, and the heat conductive plate 130 and/or the reflective cover 111 are provided with circulation channels 131, 132, and the circulation channels connect the reflective cover 111 and the cooking chamber 121. At least a part of the airflow generated when the fan 114 is in operation enters and exits the circulation channel, thereby generating air convection between the reflective cover 111 and the cooking chamber 121, as shown by the arrows in FIG. 1. This air convection is used to transfer the heat generated by the heating element 113. Here, the food to be cooked in the cooking chamber 121 is heated by the radiant heat generated by the heating element 113 and the convective heat generated by air convection.

The heat conductive plate 130 can prevent most of the grease from entering the cover body 110. The heat conductive plate 130 serves to separate the reflective cover 111 from the cooking chamber 121, so that as much grease as possible remains in the cooking chamber 121, and the user can clean it quickly and conveniently after each use. Since the heat conductive plate 130 has high thermal conductivity, the heating element 113 can still heat the food in the cooking chamber 121 in the form of radiation convection.

In some embodiments, as shown in FIG. 1, a first guiding structure 140 may also be provided, and the first guiding structure 140 is configured to guide the airflow passing through one of the circulation channels 131, 132 into the cooking chamber 121 along a predetermined direction.

Due to the addition of the heat conductive plate 130, the air flow has undergone certain changes compared with the original traditional air fryer, especially the air flow channel from the reflective cover 111 downward to the cooking chamber 121 has changed. In other words, the airflow can only flow out from the circulation channel of the heat conductive plate, and the flow area becomes smaller, which changes the air volume distribution in the frying receptacle and the temperature field. In order to maintain the original uniform distribution of the air volume in the frying receptacle as much as possible, so as to obtain a better food effect, the first guiding structure 140 is provided, especially between the reflective cover and the frying receptacle.

In the embodiment shown in FIG. 1, the cover body 110 also has a drive element 115, such as a drive motor. The drive element 115 is configured to drive the fan 114 to rotate so as to generate airflow, thereby generating air convection between the reflective cover 111 and the cooking chamber 121 as shown by the arrows in FIG. 1. In the embodiment shown in FIG. 1, the cover body 110 further includes a motor cover 116, and a heat dissipation cavity 117 is formed between the motor cover 116 and the reflective cover 111. In the heat dissipation cavity, another fan 118 is arranged above the fan 114, and the drive element 115, such as a drive motor, is also used to drive the other fan 118 to rotate.

Here, the drive element 115 is used to drive the fans 114 and 118 to rotate simultaneously. For example, the drive element 115 is a drive motor, and the fans 114 and 118 are mounted on the same motor shaft as the drive motor.

The motor cover 116 is made of plastic, for example, and is used to prevent the hot air generated in the reflective cover 111 from radiating outward, thereby preventing the temperature of components such as the PCB arranged on the top of the cover body 110 from being too high. The other fan 118 has centrifugal air blades for sucking the cold air from the outside into the motor cover to cool the hot air.

In addition, the cold air outlet of the motor cover 116 and the hot air outlet in the reflective cover 111 can be merged together, so that the temperature of the air emitted to the outside is lower, avoiding scalding the user.

FIG. 2 shows a second embodiment of an air fryer according to the present utility model. Different from the first embodiment shown in FIG. 1, in the second embodiment shown in FIG. 2, the heat conductive plate 130 is disposed below the heating element 113. This further prevents the grease in the cooking chamber 121 from adhering to the heating element 113, thereby enabling the heating element 113 to be cleaned better. For other features of the air fryer according to the second embodiment, reference may be made to the first embodiment and will not be repeated here.

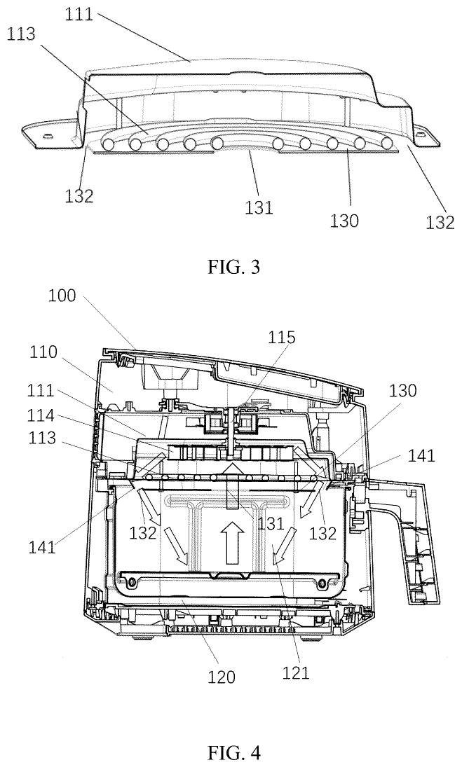

In some embodiments, as shown in FIGS. 1 to 3, a first circulation channel 131 is provided in the middle of the heat conductive plate 130, and a second circulation channel 132 is provided between the heat conductive plate 130 and the reflective cover 111, so that at least a portion of the airflow generated by the operation of the fan 114 flows from the reflective cover 111 into the cooking chamber 121 via the second circulation channel 132 and flows back from the cooking chamber 121 to the reflective cover 111 via the first circulation channel 131, so as to form air convection. By designing an air circulation channel in the middle of the heat conductive plate and also designing air circulation channels around the heat conductive plate and the reflective cover 1, it is possible to achieve unimpeded air circulation and maintain smooth air convection.

Here, the first air guiding structure 140 may be configured to guide the airflow passing through the second circulation channel 132 into the cooking chamber along a predetermined direction.

Of course, the present utility model is not limited to the above-mentioned arrangement of the first circulation channel 131 and the second circulation channel 132. Another circulation channel may also be arranged between the first circulation channel 131 and the second circulation channel 132 to increase air circulation and improve heating efficiency. This utility model does not limit this.

In some embodiments, the heat conductive plate 130 is preferably made of an easy-to-clean material, for example, the heat conductive plate 130 is constructed as a glass plate or a metal plate.

In some embodiments, the first guiding structure 140 has an inclined guide plate 141, which is configured to guide the airflow passing through one of the circulation channels 132 toward the middle of the cooking chamber 121 or around the cooking chamber 121. Here, according to the specific needs of the air fryer, the hot air can be guided to the middle of the cooking chamber 121 or to the surroundings of the cooking chamber 121 through the guide plate 141 to obtain a variety of temperature fields and air volume distribution fields, thereby meeting the needs of different types of air fryers.

In some embodiments, different from the second embodiment shown in FIG. 2, in the third embodiment shown in FIG. 4, the first guiding structure 140 has an inclined guide plate 141, and the guide plate 141 is bent or inclined toward the center of the frying receptacle. The guide plate 141 can make the airflow generated by the fan 114 flow toward the middle of the cooking chamber 121, so that the hot air flowing toward the middle of the cooking chamber 121 has higher thermal energy and can effectively increase the temperature in the middle of the cooking chamber 121. In addition, by guiding the airflow toward the middle of the cooking chamber 121, the difference between the temperature in the middle of the cooking chamber 121 and the temperature around the cooking chamber 121 is reduced, so that the temperature distribution in the cooking chamber 121 is more uniform, which is conducive to heating food. For other features of the air fryer according to the third embodiment, reference may be made to the first and second embodiments, and no further details will be given here.

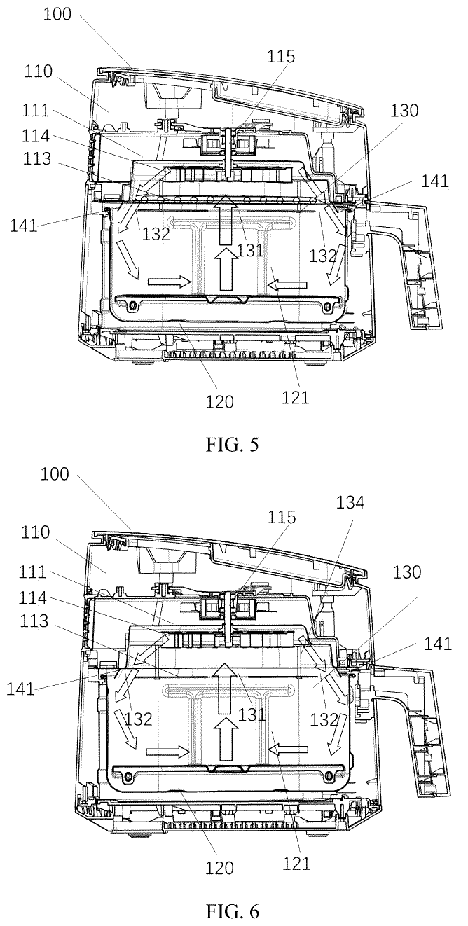

Alternatively, in some other embodiments, different from the second embodiment shown in FIG. 2, in the fourth embodiment shown in FIG. 5, the first guiding structure 140 has an inclined guide plate 141, and the guide plate 141 is bent or inclined away from the center of the frying receptacle. The guide plate 141 can make the airflow generated by the fan 114 cover a wider area, so that the hot air circulation covers a wider area, which can effectively increase the temperature around the cooking chamber 121. In addition, since the airflow is directed to the surroundings of the cooking chamber 121 and thus away from the first circulation channel 131, more airflow will enter the bottom space of the cooking chamber 121, so that the back of the food placed in the cooking chamber 121 can also be exposed to more hot airflow, effectively improving the uniformity of food cooking. Regarding other features of the air fryer according to the fourth embodiment, reference may be made to the first to third embodiments and will not be repeated here.

In some embodiments, different from the third embodiment shown in FIG. 5, in the fifth embodiment shown in FIG. 6, the heat conductive plate 130 and the heating element 113 are constructed as an integral heating plate. In other words, the heat conductive plate 130 has the heating function of the heating element 113, that is, the heat conductive plate 130 is also a heating element. By replacing the traditional heating tube with an integrated heating plate, the space occupied by the original complex heating tube is released, making the entire cover space more compact. In addition, since the plate 130 with a heating function is used, the intermediate heat transfer medium is reduced, and the radiation heat efficiency can be effectively improved. Regarding other features of the air fryer according to the fifth embodiment, reference may be made to the first to fourth embodiments, and no further details will be given here.

In some embodiments, the heating plate is constructed based on one of thick film heating technology, heat-generating thin film sheet technology, and graphene technology.

In some embodiments, the heat conductive plate 130 and/or the first flow-guiding structure 140 are fixed on the reflective cover 111, for example, fixedly connected to the reflective cover 111 by bolts. Of course, the connection methods include but are not limited to bolt connection, riveting, welding, etc. can also achieve the same effect.

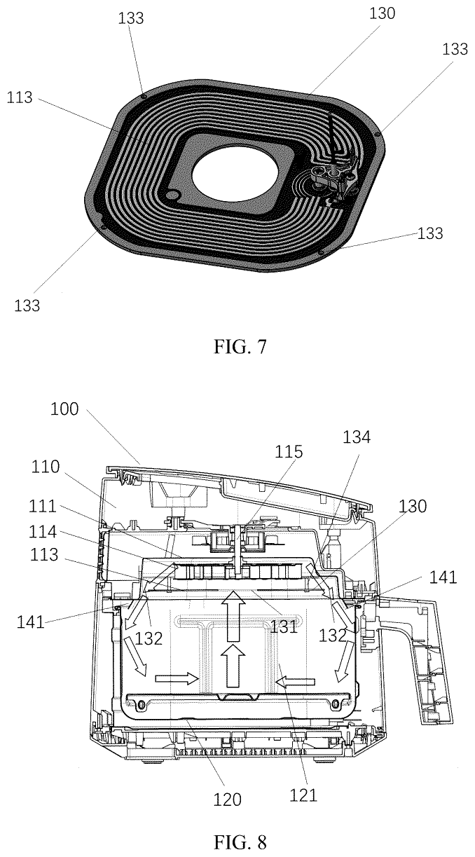

In a specific example, as shown in FIG. 7, the heating plate is constructed based on thick film heating technology, and screw holes 133 are provided around the heating plate for fixed connection with the reflector.

In some embodiments, the heat conductive plate 130 and/or the first air-guiding structure 140 are configured to be movable relative to the fan 114, and in particular, are disposed on the reflective cover 111 in a manner that allows them to be movable relative to the fan 114. For example, when the heat conductive plate 130 is connected to the reflective cover 111 by means of the bolts 134, as shown in FIG. 6, the distance of the heat conductive plate 130 relative to the fan 114, i.e., the height of the heat conductive plate 130, can be adjusted by adjusting the length of the bolts 134 to adjust the pressure of the space above the heat conductive plate 130, the flow rate of the air, and the flow direction, so as to obtain the best air circulation most suitable for a specific air fryer. In addition, the change of the height of the heat conductive plate 130 will also change the noise of the whole machine. The lower the height, the lower the noise when the whole machine is working.

In the sixth embodiment shown in FIG. 8, different from the fifth embodiment shown in FIG. 6, the heat conductive plate 130 has a higher height and a smaller distance from the fan 114. Regarding other features of the air fryer according to the sixth embodiment, reference may be made to the first to fifth embodiments, and no further details will be given here.

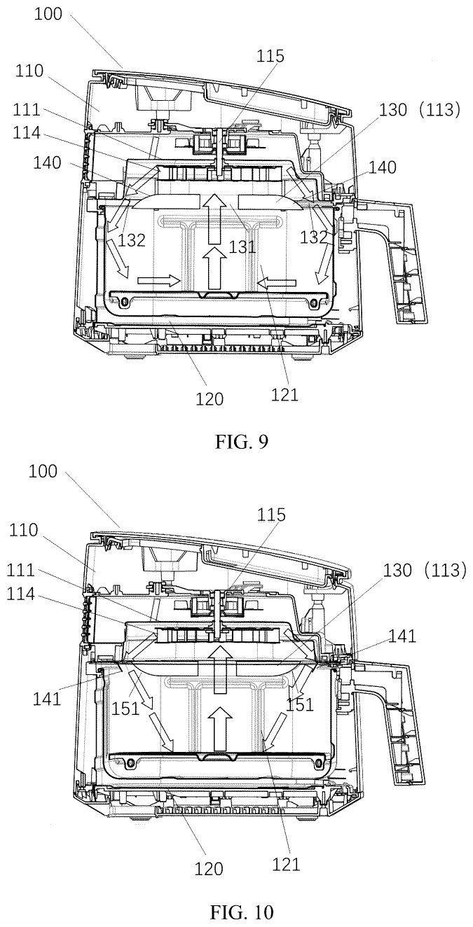

In some embodiments, different from the sixth embodiment shown in FIG. 8, in the seventh embodiment shown in FIG. 9, the first flow guiding structure 140 is disposed on the heat conductive plate 130, for example, disposed on the edges around the heat conductive plate 130. By providing the first flow guiding structure on the plate 130, compared with the flat plate structure, providing a streamlined first flow guiding structure around the edges of the plate can reduce the static pressure of the gas. The first flow guiding structure tends to be parallel to the flow direction of the airflow, making the airflow flow smoother, thereby improving the overall airflow circulation effect. Regarding other features of the air fryer according to the seventh embodiment, reference may be made to the first to sixth embodiments, and no further details will be given here.

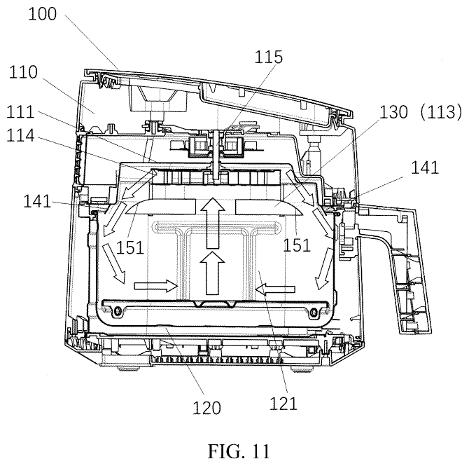

In some other embodiments, as shown in FIGS. 10 and 11, different from the fifth embodiment shown in FIG. 8, the first guiding structure is fixed on the reflective cover 111, and a second guiding structure independent of the first guiding structure is provided on the heat conductive plate 130, and the second guiding structure is configured to cooperate with the first guiding structure to guide the airflow passing through one of the circulation channels into the cooking chamber 121 along a predetermined direction. By providing a second flow guiding structure on the plate 130, compared with a flat plate structure, providing a streamlined second flow guiding structure around the edges of the plate can reduce the static pressure of the gas. The second flow guiding structure tends to be parallel to the flow direction of the airflow, further improving the overall airflow circulation effect.

In the eighth embodiment shown in FIG. 10, the first flow guiding structure has an inclined flow guide plate 141, which is bent or inclined toward the center of the frying receptacle, and the second flow guiding structure is constructed as an arc portion 151 around the edge of the heat conductive plate 130, and the tangent of the arc portion 151 is inclined toward the center of the frying receptacle. The guide plate 141 of the first guiding structure cooperates with the arc portion 151 of the second guiding structure to make the airflow generated by the fan 114 flow toward the middle of the cooking chamber 121, so that the hot air flowing toward the middle of the cooking chamber 121 has higher thermal energy, which can effectively increase the temperature in the middle of the cooking chamber 121. In addition, by guiding the airflow toward the middle of the cooking chamber 121, the difference between the temperature in the middle of the cooking chamber 121 and the temperature around the cooking chamber 121 is reduced, so that the temperature distribution in the cooking chamber 121 is more uniform, which is conducive to heating food. Regarding other features of the air fryer according to the eighth embodiment, reference may be made to the first to seventh embodiments, which will not be described in detail here.

Alternatively, in the ninth embodiment shown in FIG. 11, the first guiding structure has an inclined guide plate 141, which is bent or inclined away from the center of the frying receptacle, and the second guiding structure is constructed as an arc portion 151 around the edge of the heat conductive plate 130, and the tangent of the arc portion 151 is inclined away from the center of the frying receptacle. The guide plate 141 of the first guiding structure cooperates with the arc portion 151 of the second guiding structure, so that the airflow generated by the fan 114 covers a wider area, so that the hot air circulation covers a wider area, which can effectively increase the temperature around the cooking chamber 121. In addition, since the airflow is directed to the surroundings of the cooking chamber 121 and thus away from the first circulation channel 131, more airflow will enter the bottom space of the cooking chamber 121, so that the back of the food placed in the cooking chamber 121 can also be exposed to more hot airflow, effectively improving the uniformity of food cooking. Regarding other features of the air fryer according to the ninth embodiment, reference may be made to the first to eighth embodiments, and no further details will be given here.

The features or feature combinations mentioned above in the specification, drawings and claims may be used in any combination or alone as long as they are meaningful within the scope of the present utility model and do not contradict each other.

The above description is only a preferred embodiment of the utility model, and does not limit the patent scope of the utility model. All equivalent transformations made by using the contents of the utility model specification and drawings under the inventive concept of the utility model, or direct or indirect application in other related technical fields are included in the patent protection scope of the utility model.

We, claim:

1. An air fryer, comprising a cover body and a frying receptacle, wherein the cover body has a reflective cover for accommodating a heating device, the frying receptacle has a cooking chamber for placing food, the cover body is constructed to cover the frying receptacle, and the heating device comprises a heating element and a fan located above the heating element;
wherein the heating device also includes a heat conductive plate arranged below the fan;
wherein the heat conductive plate and/or the reflective cover includes at least one circulation channel that connects the reflective cover and the cooking chamber such that at least a part of airflow generated when the fan operates flowing through the circulation channel.

2. The air fryer according to claim 1, wherein the heat conductive plate is arranged below the heating element.

3. The air fryer according to claim 1, wherein the heat conductive plate and the heating element are combined as an integrated heating plate.

4. The air fryer according to claim 3, wherein the integrated heating plate includes thick film heating technology.

5. The air fryer according to claim 3, wherein the integrated heating plate includes thin film heating technology.

6. The air fryer according to claim 3, wherein the integrated heating plate includes graphene heating technology.

7. The air fryer according to claim 1, further comprising a first guiding structure, wherein the first guiding structure is configured to guide the airflow passing through the circulation channel into the cooking chamber in a predetermined direction.

8. The air fryer according to claim 7, wherein the first guiding structure has a guide plate, which is configured to guide the airflow passing through the circulation channel toward the middle of the cooking cavity or around the cooking chamber.

9. The air fryer according to claim 1, wherein a first circulation channel is provided in the middle of the heat conductive plate, and a second circulation channel is provided between the heat conductive plate and the reflective cover, so that at least a part of the airflow generated by the fan flows from the reflective cover into the cooking chamber through the second circulation channel and flows back from the cooking chamber to the reflective cover through the first circulation channel.

10. The air fryer according to claim 9, further comprising a first guiding structure that guides the airflow passing through the second circulation channel into the cooking chamber along a predetermined direction.

11. The air fryer according to claim 1, wherein the heat conductive plate is fixed on the reflective cover.

12. The air fryer according to claim 1, wherein the heat conductive plate is movable relative to the fan.

13. The air fryer according to claim 12, wherein the heat conductive plate is attached to the reflective cover.

14. The air fryer according to claim 7, wherein the first flow guiding structure is fixed on the reflective cover.

15. The air fryer according to claim 7, wherein the first flow guiding structure is movable relative to the fan.

16. The air fryer according to claim 7, wherein the first flow guiding structure is attached to the heat conductive plate.

17. The air fryer according to claim 7, wherein the first flow guiding structure is attached to the reflective cover, and a second flow guiding structure is attached to the heat conductive plate that also guides the airflow passing through the circulation channel into the cooking chamber in a predetermined direction.
